(19) United States
(12) Patent Application Publication
(10) Pub. No.: US 2006/0256814 A1
(43) Pub. Date: Nov. 16, 2006

(54) Ad hoc computer network

(75) Inventor: J. Claude Caci, Owego, NY (US)

Correspondence Address: MILES & STOCKBRIDGE PC, 1751 PINNACLE DRIVE, SUITE 500, MCLEAN, VA, 22102-3833, US

(73) Assignee: Lockheed Martin Corporation, Bethesda, MD (US)

(21) Appl. No.: 11/128,388

(22) Filed: May 13, 2005

(51) Int. Cl. H04J 3/16; H04J 3/04

(52) U.S. Cl. 370/466; 370/535

(57) ABSTRACT

An ad hoc network formed of electronic communication control devices for scanning each packet that crosses an interface and allowing a packet through the network interface only if the packet meets policy criteria, otherwise rejecting the packet. The electronic communication control devices have a unique communication method that exists between electronic communication control device chipsets. This method is transparent to other devices on the network so that only an electronic communication control device can communicate with another electronic communication control device. This gives a network interface adapter equipped with an electronic communication control device the ability to form an ad hoc network and communicate with other interface adapters and port line cards throughout the ad hoc network. This ad hoc network allows electronic communication control device equipped network interface units to promulgate a communication policy between units. Rejection may be of several forms including deliberate TCP/IP rules manipulation. The ad hoc network may identify and repel denial of service attacks and impede virus propagation.

### BRIEF DESCRIPTION OF THE DRAWINGS

The present invention will be described with reference to the accompanying drawings, wherein:

FIG. 1 is a block diagram of an exemplary embodiment of an electronic communication control device in accordance with the present invention;

FIG. 1A is a block diagram showing an exemplary embodiment of an embedded router module within an electronic communication control device in accordance with the present invention;

FIG. 2 is a diagram showing a conventional network interface;

FIG. 3 is a block diagram of an exemplary network interface adapter having an electronic communication control device in accordance with the present invention;

FIG. 4 is a block diagram of an exemplary line card for use in a router or switch having an electronic communication control device of the present invention;

FIG. 5 is a block diagram of an exemplary chip-level architecture of an electronic communication control device in accordance with the present invention;

FIG. 6 is a block diagram of an exemplary ad hoc network;

FIG. 7 is a block diagram showing an example of ad hoc network policy table formation and propagation; and

FIG. 8 is block diagram of an example of ad hoc network policy table propagation.

### DETAILED DESCRIPTION

An “ad hoc” computer system or network may be two or more computers, processors, or network interfaces forming a network for a particular purpose.

In an exemplary embodiment, an ad hoc network may be formed from network interfaces that have an electronic communication control device. The electronic communication control device, when used in an ad hoc network, may perform one or more of the following: collecting communications policy information from the local user, creating a communications policy table, analyzing incoming data traffic for the local machine against policy table, forwarding data packets that meet policy table criteria to the local machine, applying deceptive or direct methods to repel unwanted communications input to the local machine, creating covert electronic communication control device to electronic communication control device connection messages, propagating the policy table back through the ad hoc network, translating IPv6 to IPv4 as necessary, providing a means for communications policy network administration, and providing multiplexing control, which may allow users to save time, computer capacity, and telecommunications capacity by reducing or eliminating unwanted data processing.

In the exemplary embodiments shown in the figures and described below, it may be shown how communications through transmission control protocol (TCP)/internet protocol (IP) addresses and ports can be controlled and managed by an ad hoc network of electronic communication control devices in accordance with the present invention. However, it should be appreciated that an ad hoc network in accordance with the present invention may be utilized with any known and/or later developed network protocols and/or network types such as Ethernet, fiber optic, radio frequency, and/or any known or later developed communications methods.

The Internet Protocol (IP) standard contains a protocol field that identifies the next lower level TCP, called a port. Ports are the numerical names of the logical link ends. Ports identify packets like mail and hypertext. Ports provide end point application mapping to unknown callers. A certain number of ports may be defined as well-known ports, which are used for particular purposes, such as, for example, port 80 is typically used for hypertext. The well-known ports are common across a variety of operating systems and allow the different operating systems to interoperate by specifying how communications and transactions are processed. The Internet Engineering Task Force (IETF) has stipulated that to the extent possible the same TCP port assignments are used with user datagram protocol (UDP) service. UDP is often associated with custom applications. Custom applications or proprietary applications can often skirt rules and standards designed for interoperability between different computer systems. For example an email program can be designed to follow IETF request for comment (RFC) standards. RFCs are the working notes of the Internet research and development community and typically contain protocol and model descriptions, experimental results, and reviews. Internet standard protocols are, by process, written up as RFCs. A software developer can introduce an email program that runs proprietary connections and IETF RFC standards at the same time, such as, for example, Microsoft Outlook™, Qualcomm Eudora™, and the open standard SendMail. In contrast to these email programs, it may be difficult to write email filter and antivirus software capable of performing the security functions that a physical electronic communication control device is capable of, such as, becoming a control link in the communications chain, uniquely enforcing communications policy while remaining invisible to the application and processing the communications data at an acceptable rate.

Within the Internet regulatory and user communities, a transition from IPv4 to IPv6 is occurring. Under IPv4, a network address is comprised of 32 bits. Under IPv6, a network address is comprised of 128 bits. Different software may be required to process IPv6 message traffic. The number of Internet legacy systems currently using IPv4 is very large compared to those using Ipv6 at the present time, and it may take a long time before all systems using the Internet can be converted to IPv6.

Software to perform a translation from IPv4 to IPv6 has been developed. Also, dual stack IP applications for older machines have been developed that will help facilitate the transition. However, it may be desirable to move the translation between older and newer protocols from the host system level to a hardware support level. In an exemplary embodiment of an electronic communication control device, network protocol translation and IPv4 to IPv6 translation, may be performed at the network interface card (NIC) level. In such a construction the legacy host operating system may not be affected by the transition from IPv4 to IPv6. If a host system is running on IPv4 in a mixed network, then the electronic communication control device may recognize the IPv4 stack and automatically translate IPv6 for the legacy host system. Older systems can be IPv6 enabled simply by changing the existing NIC to a NIC including an electronic communication control device, possibly giving the older systems longer effective life.

Servers are sometimes outfitted with multiple Ethernet NICs and used as routers. By including NICs containing electronic communication control devices, these routers would also be IPv6 enabled. Dedicated routers could also be upgraded to IPv6 when outfitted with port adapters including an electronic communication control device. The electronic communication control device may perform the conversion process at line speed rates, thereby improving performance.

The IETF has specified a number of tools to help in the migration to IPv6, such as running a stack having an IPv4 stack and an IPv6 stack concurrently and using the appropriate version for communications. An exemplary electronic communication control device is IPv6 compliant and able to translate between IPv6 frames and IPv4 frames. When IPv4 translation is not practical, the electronic communication control device will manage the protocol internally on behalf of the host system. The change from 32-bit addressing to 128-bit addressing means that the address resolution protocol (ARP) and reverse address resolution protocol (RARP) will be quite different in IPv6. Many private networks use two sets of IP addresses: one for internal connections and one for external connections. In IPv4, internal addresses need not be valid registered addresses and, in fact, often are not. In IPv4 those addresses used for external connectivity must be valid registered addresses. The IETF has specified tools that will allow the two protocols to exist side by side within a host system. This will be a common approach during the transition from IPv4 to IPv6. A drawback to this approach is that it requires extra system resources such as memory and processing capacity. If a computer can handle the extra processing load, then a primary use of the electronic communication control device may be for communications control. However, some computer systems will be noticeably slower and burdened by the extra demand of the dual stack software implementation. The electronic communication control device can help alleviate the problem by running the IPv6 stack outside of the host system and translating the packets to IPv4 making the network appear to be IPv4 to the host system. Thus, the host system will enjoy two benefits, communications control and computer resource conservation. The electronic communication control device has the processing capacity to operate the stack at very high line speeds. Older host systems incorporating an electronic communication control device can continue to interface to an IPv6 network and interoperate, lengthening the service life of the systems.

In an exemplary embodiment, an electronic communication control device may be designed at the chipset level, permitting the electronic communication control device to be embedded within a NIC. Router and switch communications equipment may also use line cards to interface wide area network circuitry like asynchronous transfer mode (ATM) and T1 (a digital transmission link with a capacity of 1.544 Mbps). Line cards, also called port cards, may also be equipped with an electronic communication control device in a manner similar to a NIC, but possibly having differing characteristics from the NIC embodiment.

In another exemplary embodiment, an electronic communication control device comprises acceleration hardware, operating software/firmware, and a user interface. The acceleration hardware comprises one or more high-speed processors, in a parallel operating arrangement, which can operate at line speeds without slowing down the network or a host system. High speed is accomplished by developing a finely tuned logic structure that can execute a complex task within a single clock cycle; similar to the way a reduced instruction set computer (RISC) executes instructions. The electronic communication control device may have a combination of RISC general instruction processors and programmable logic devices (PLDs) for processing specialized instructions.

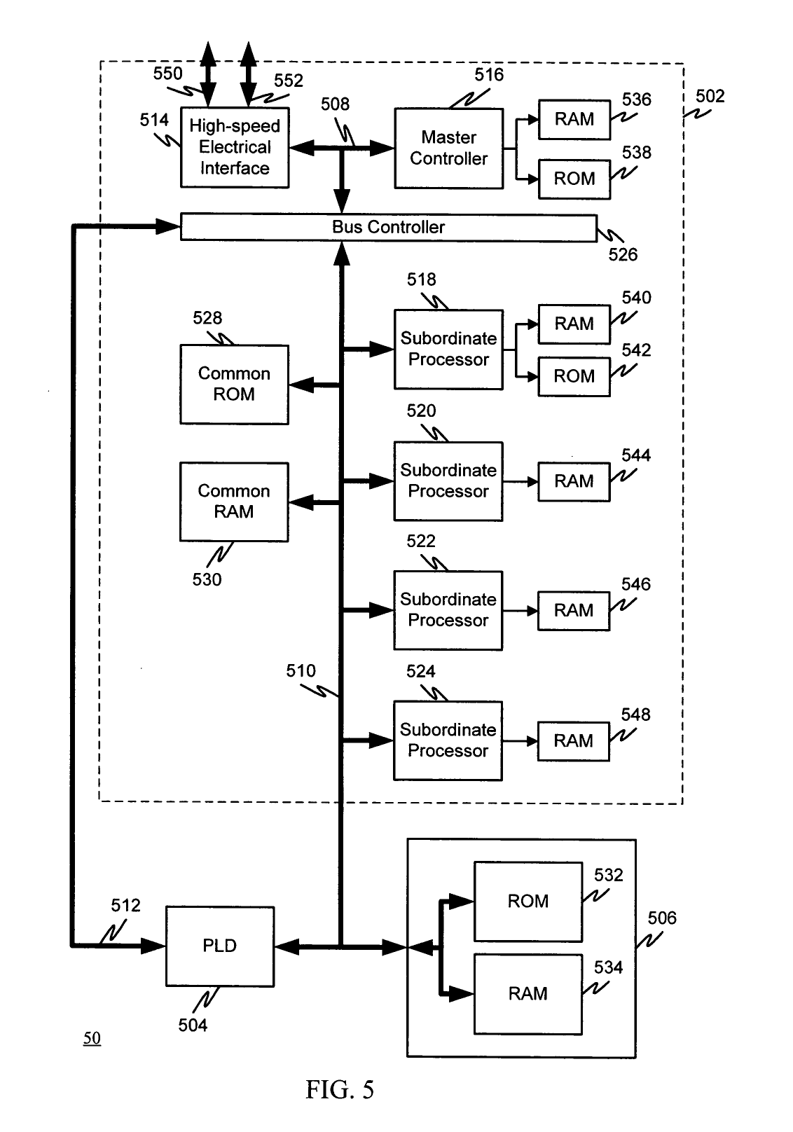

Further, the electronic communication control device may comprise a PLD accelerator, as shown in FIG. 5. The electronic communication control device hardware may have a number of replicated structures operating in parallel to perform specific logic operations designed to rapidly encode and decode Internet data packets. The processors of the electronic communication control device may be connected by a number of address and data busses to high-speed memory and storage memory. Hardware constructed according to the architecture of the electronic communication control device, along with control software and optional application software, forms an electronic communication control device.

For example, an electronic communication control device may be built using RISC processors and field programmable gate array (FPGA) technology, as the programmable logic device. It may be desirable that an electronic communication control device be extremely small, simple, and fast. It may also be desirable that the electronic communication control device execute a number of highly specific, unique instructions as rapidly as possible, and preferably within one processor clock cycle. The electronic communication control device architectural logic components may be small, easy to replicate and connected by multiple busses within the chip. The amount of electronic communication control device control program code may be relatively small and succinct. There are a number of applications that may be encoded within the chipset. Each RISC processor may process the same instruction set independently of other units.

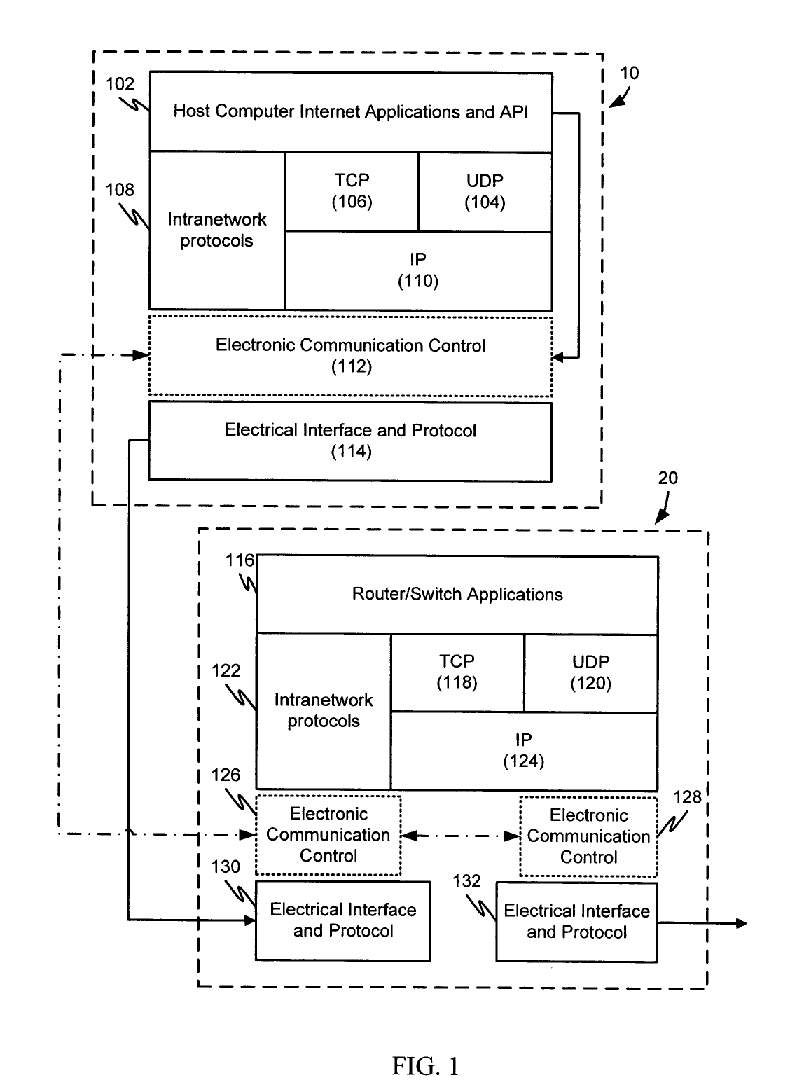

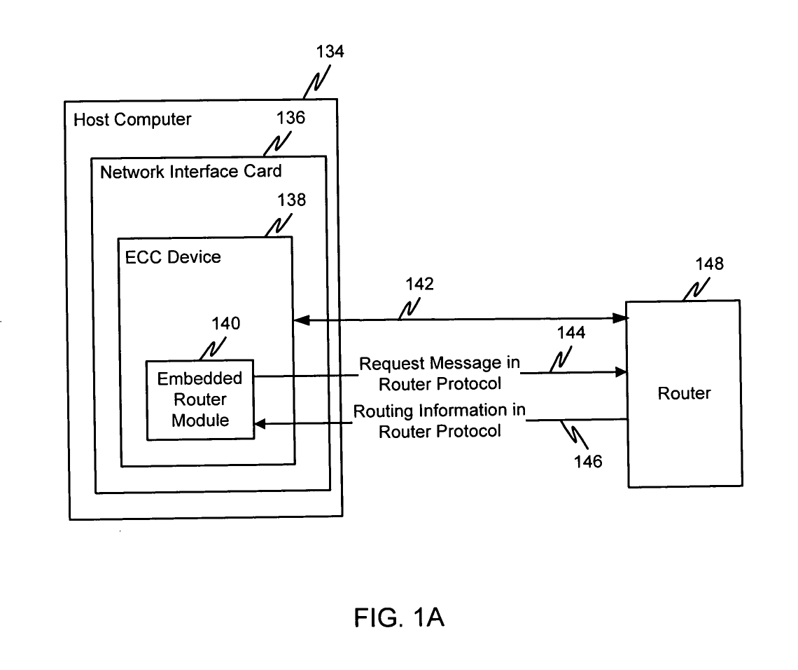

In a data switch, such as a router or network switch, connections are completed by a system of logic circuitry connecting data packets by protocol rules rather than electrical signals. This is a form of logical time division multiplexing. Data switches may be analogized to mechanical sieves used for grading material according to size and shape. In a data switch, messages may be graded according to criteria contained in a connection policy table from which the connection is made. If the result of grading against the criteria is negative, the packet is not allowed to pass and a message is returned to the sender stating the reason the message was not allowed to pass. One problem with conventional switches is that the connection policy table may not be modifiable by a user to refuse unwanted connections. Another serious problem with conventional switches is that the policy table is not promulgated through the network to keep unwanted packets off larger branches of the network. The electronic communication control device of the present invention provides a potential solution to these problems. The electronic communication control device is implemented in fast microcircuit hardware that can be embedded into networking circuitry of any type and speed. FIG. 1 shows an exemplary embodiment using Ethernet because it is a common networking standard. In another example, the electronic communication control device may be embedded into router ports for specific transmission network interface matching, such as ATM, synchronous optical network (SONET), T-carrier or frame relay. By embedding the electronic communication control device into router or switch ports, older equipment may be economically upgraded. Further, the electronic communication control device can be built within new network equipment such as routers and switches, or embedded into local area network circuitry such as ten one hundred based Ethernet or Gigabit based Ethernet. The electronic communication control device of the present invention is not dependent on media type or the network interface layer of the OSI (Open System Interconnection model) or the Defense Advanced Research Projects Agency (DARPA) host-to-host interconnection model.

FIG. 1 shows an Ethernet NIC having an exemplary embodiment of the electronic communication control device constructed within a host system and within a router or switch. In particular, a user host system 10 includes host computer applications programs and application programming interfaces (API) 102, a user datagram protocol (UDP) 104 software interface layer, a transmission control protocol (TCP) 106 software interface layer, an intranetwork protocol 108 software interface layer, an Internet protocol 110 software interface layer, an electronic communication control device 112, and electrical interfaces and protocols 114 for a network protocol, such as Ethernet. A router/switch 20 includes router/switch applications 116, a TCP software interface layer 118, a UDP software interface layer 120, an intranetwork protocol software interface layer 122, an Internet protocol software interface layer 124, an electronic communication control device dedicated to Ethernet 126, an electronic communication control device dedicated to wide area networks (WAN) 128, an Ethernet electrical interface 130, and a WAN electrical interface 132.

The electronic communication control device 112 within the user host system 10 and the electronic communication control devices 126 and 128 within the router/switch 20 each comprise processing modules for a unique protocol used to communicate exclusively with other electronic communication control device equipped network equipment, a dual TCP/IP stack (for example, having one IPv4 stack and one IPv6 stack), packet analysis, multiplex applications, protocol translation (such as, IPv4 to IPv6), and encryption/decryption.

In operation, Ethernet control signals pass through the electronic communication control device 112 and are processed as needed before being sent to the Ethernet electrical interface 114. The Ethernet electrical interface 114 has registers for storing information needed to construct an Ethernet frame. The Ethernet electrical interface is set up for a transmission sequence and data is fed through the computer interface to the Ethernet electrical interface, which builds an Ethernet frame and transmits it. The Ethernet electrical interface listens for packet collisions from the network using collision sense multiple access with collision detection methods (CSMA/CD), which is part of the Institute of Electrical and Electronics Engineers (IEEE) 802.3 Ethernet standards. If a packet is correctly received, the circuitry sets register values that can be read by the computer interface circuitry and the next data packet is processed. If the sent packet was not well received, the sent packet is retransmitted. The process is repeated until the host computer has transmitted all the packets associated with an Ethernet transaction.

Ethernet usually has two types of communications associated with it. One is intranetwork (i.e. staying within the Ethernet) and the other is internetwork (i.e. crossing over into a routed network). The intranetwork Ethernet frames are managed by protocols like IPX or NetBIOS. There are standards for computer applications to access the Network Driver Interface Specification (NDIS) directly or they can rely on standards like IPX, Sequential Packet exchange (SPX) or NetBIOS. This gives applications a way to make transactions over the Ethernet. In the internetwork environment, the standards govern how specific operations are performed, like email and hypertext. Internet web browser technology has evolved to a point where transactions can be carried on through the browser interface. Email is similar in that hypertext messages can toggle between an email application presentation and a browser presentation. These kinds of data packets go over the routed network and involve TCP/IP.

In the transition period when IPv4 and IPv6 may both be present, an electronic communication control device may be of value in translating between IPv4 and IPv6. Any confusion during a transition period may also provide an opportunity for further network abuse, such as sending unwanted communications. An electronic communication control device in accordance with the present invention may reduce or eliminate network abuse. An exemplary embodiment of an electronic communication control device as shown in FIG. 1, may be coupled in the critical path from the network to the computer. The electronic communication control device may operate in IPv4 and in IPv6, translating between the two as needed.

FIG. 1 shows how an electronic communication control device of hardware and software can be implemented into an existing NIC design and populated into a user computer. The user computer need not be aware of the electronic communication control. The electronic communication control device can operate according to Ipv4, IPv6, or any newer IP protocol. The hardware consists of programmable logic devices designed to operate an exclusive instruction set, thus making the hardware operation very fast.

Parallel processing, when coupled with programmable logic, can be implemented at the microcircuit level. Performing short, highly repetitive analysis tasks on fast moving inline data, such as may be required for electronic communication control, is a situation that is well suited for parallel processing techniques. The electronic communication control device is a chipset having parallel processors with embedded software that can be constructed to fit within a NIC design or router port design.

In operation, the electronic communication control device interfaces the Ethernet logic hardware at the electrical level on one side and the bus processor logic on the other side as shown in FIG. 1. Logically it interfaces the host computer Internet Protocol. It also interfaces with other protocols that coexist with IP such as Novel's Internetwork Packet eXchange (IPX) and Microsoft's Network Basic Input/Output System (NETBIOS), which are primarily for intranetwork use, whereas IP is for routed network use. Above the IP layer are the Transmission Control Protocol (TCP) and User Datagram Protocol (UDP) layers. These protocols in turn interface the application layer. The electronic communication control device can perform packet analysis up through the protocol stack to the application layer. The electronic communication control device can use IPv6 and can translate to IPv4, or another protocol, for the local host. The local host is not aware of the translation. Special translation software is not required for the host. The electronic communication control device analysis will correctly identify if the local host is using IPv4 and perform translation. If the local router is not IPv6 compliant, then the electronic communication control device will use the most appropriate method to interface with the router. The electronic communication control device has a communication software method that seeks out other electronic communication control devices in the IP path. This adds a small amount of overhead to the communication. It allows the electronic communication control device to communicate data, such as, for example, policy table elements to distant electronic communication control devices.

Another function of the electronic communication control device is to gather information for path connections. It is possible that routers along the path may not share path connection information. The electronic communication control device has an alternative method to gather this information. The electronic communication control device protocol can be tunneled within the connection so the router and other computers are not aware of this logical link. This type of covert connection is represented by the dashed line connecting the electronic communication control device 112 and the electronic communication control device 126 shown in FIG. 1. Also, the electronic communication control devices 126 and 128 may communicate using covert messages placed within normal network traffic. The use of encryption is selectable.

As mentioned above, the electronic communication control device has multiple methods of determining path connections. The information about path connections can be used to identify other electronic communication control devices on the network, and may also be used in a multiplex control strategy to identify a node (or nodes) where blocking of unwanted traffic, or other processing, may be desirable. One way the electronic communication control device can get path connection information is through an embodiment having an embedded router module. The embedded router module may be implemented in hardware, software, or a combination of hardware and software. Further, the embedded router module may be a partial or a full implementation of a router.

The embedded router module may perform at least some of the functions of a conventional router. The embedded router module is capable of communicating with other routers in one or more router protocols, for example router discovery protocol (RDP). For example, an embedded router module may communicate with a router through the network connection on the network interface card where the ECC device resides.

By using the various router protocol capabilities of the embedded router module, the ECC device is able to obtain information about neighboring routers and may also obtain routing information about the network.

The construction of the ECC device having an embedded router module within a NIC card may provide the ECC device with an enhanced capability for multiplex control and may represent a new way of increasing the awareness of the surrounding network in a terminal node, such as a PC. In general, terminal node is used in this specification to mean any processor on a network that is connected to only one router, data switch, or other processor. It is also possible to construct a line card (for a switch, router, or other network device) including the ECC device with an embedded router module.

An example of uses for the routing information include determining the topology of the network in order to help identify other ECC equipped nodes/routers and in determining which points in the network will be effective to block unwanted traffic. Router information may not normally be available to a NIC card, and even if it were, conventional NIC cards may not constructed to make use of routing information.

Also, the routing information may be used to analyze any incoming URLs (for example, in html data or in email data) to verify the true destination that the URL will access and block the URL if, according to a policy table, the destination is undesirable or not allowed by policy. In contrast, conventional solutions to this problem may typically involve application software analysis of the URLs resulting in a consumption of host processor or computer resources.

The method by which the ECC device embedded router module communicates with routers causes the network interface to appear to a conventional router to be another router for purposes of gathering the routing information, discovering other ECC equipped nodes/routers on the network and formulating effective points for example, one or more “blocking nodes”, which may be effective points for blocking unwanted traffic within the ad hoc network. It should be appreciated that the blocking node may only be effective for a limited period of time and a determination of a blocking node may have to be performed periodically.

FIG. 1A is a block diagram showing an exemplary embodiment of an embedded router module within an electronic communication control device in accordance with the present invention. The attached figure shows a host computer 134, which is a terminal node, equipped with a network interface card (NIC) 136 having an ECC device 138. The ECC device 138 includes an embedded router module 140.

In operation, the NIC 136, through the embedded router module 140 of the ECC device 138 can establish both regular communications (142) and router communications (144 and 146) with a router 148. For example, the embedded router module 140 may be configured to cause the NIC card to appear as another router and communicate and receive router information from the router 148. The embedded router module 140 may request the routing information in a router protocol such that the router 148 recognizes the request as coming from a router. Then, when the router 148 send the routing information to the NIC card 136, the embedded router module 140 of the ECC device 138 can intercept the router communications and interpret the routing information by using the router protocol capability built into the embedded router module 140. The router 148 may have ECC equipped line cards or conventional line cards. The more ECC devices there are in a network, the more effective the ECC devices may be at preventing unwanted communications.

In order to more fully appreciate the advantages of the electronic communication control device, it may be helpful to contrast it with a conventional NIC.

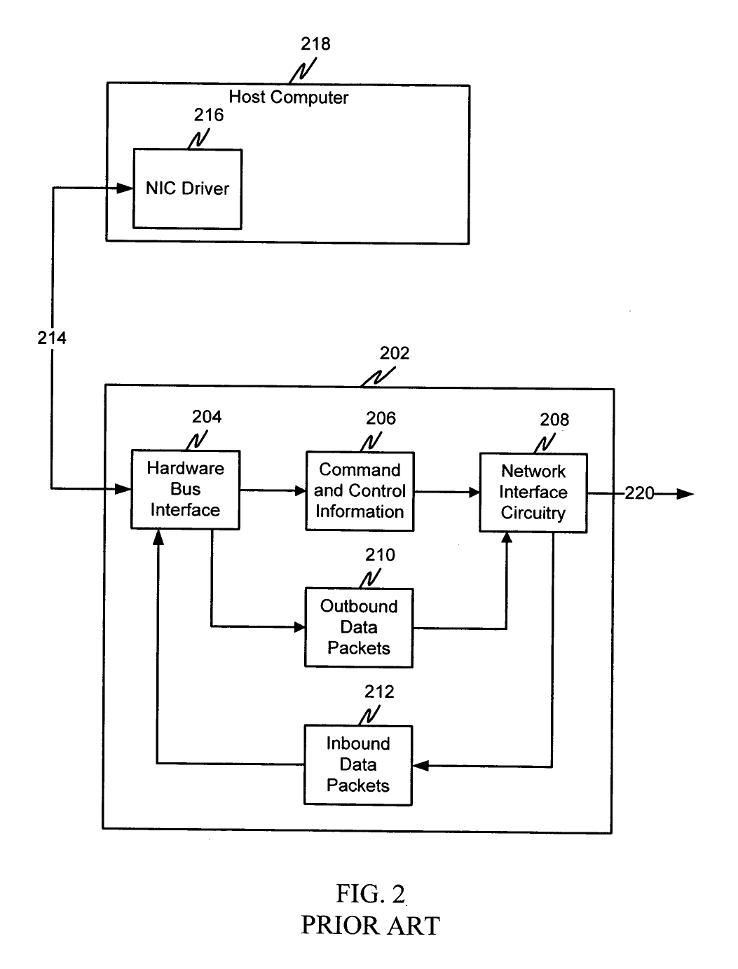

FIG. 2 is a diagram showing dataflow within a conventional NIC. In particular, within a NIC 202, there is a hardware bus interface 204, command and control information 206, network interface circuitry 208, outbound data packets 210, and inbound data packets 212. The host computer 218 includes a bus 214 and a NIC driver software module 216. There is also a local area network (LAN) connection 220, such as, for example, Ethernet. The LAN connection 220 is coupled to the NIC card 202.

The hardware bus interface 204 provides an interface from the NIC 202 to the computer 218. The computer 218 has a bus 214 through which the NIC 202 is connected to the computer 218. Through the hardware bus interface 204 the NIC 202 receives power, command and control signals, and data packets. An example of a hardware bus interface is the Peripheral Component Interconnect (PCI) specification. PCI specifies the bus control and arbitration signal scheme that devices must follow to use the bus. This bus is very common to many types of computer systems. Another form of NIC interface is one that is integrated with the computer motherboard. In the personal computer field, one example is the NIC controlled by a chipset called a Southbridge that interfaces a LAN chipset. These directly interfaced systems are very fast and bypass any PCI interface limitations.

Whether in a NIC or on a motherboard, the LAN chipset is initialized and set up for operation by using command and control signals. These signals tell the computer that the LAN is up and operating normally. They also communicate to the system the state of the LAN chipset, which includes conditions such as data coming in, LAN signal collisions, hub failures and other network states. When the computer has LAN traffic to pass, the packets must be formed according to a specific format to meet the rules of a Network Topology. Ethernet frame construction is a good example of how data is prepared for transmission within the NIC to comply with Ethernet topology.

A NIC connects a computer workstation or server to a LAN. There are two interconnections. One interconnection is to the LAN cabling system and the other is to the computer system bus. A typical bus, such as a PCI bus, may provide a means to send control signals and information to the NIC. There is circuitry in the NIC to generate the control signals for the LAN. These control signals follow the LAN protocol, for example Ethernet. It could also be other forms of Ethernet such as Gigabit Ethernet. It could be Fiber Channel. The NIC driver is a software component executing on the host computer that is designed to communicate with the NIC and the driver's function is to take high order commands and translate them to low-level instructions. For example, a high level command may be “Send(address,P,count)” where address is the numerical address of a station on the LAN, P is a pointer to a location in memory, and count is the number of bytes to pull from memory. The driver takes this directive and arranges a series of low level commands that will implement the command. The low level commands may read a series of registers to first ascertain the status of the NIC. If the status is acceptable, for example carrier present, then the driver next may set a register and strobe to accept a first data byte located at memory location P. The driver may then fetch the byte at the next location and repeat this process until the count is fully satisfied, while checking the NIC status to see if the register has received each byte. The driver may then request a checksum from the NIC and compare to the checksum the driver computed. If the checksums match then the driver will release a signal to send the data onto the LAN cable. Then NIC will exchange checksums with the remote computer and compare the two. If the comparison is valid then the results will be made available to the driver.

In the present inventor's analysis of the prior art shown in FIG. 2, the driver is in the path of the data being transmitted and received. But the purpose of the driver is to operate the NIC on behalf of the application and operating system. Therefore, the present inventor has determined that it can be problematic to task the driver with any other function that could interfere with its primary function. The NIC card has a limited number of functions it can perform. It can send data and receive data according to the protocol rules of the LAN. It can test the LAN and perform some level of diagnostics on the LAN and on itself.

Because the NIC is in the critical path between the computer and the network it is a good place to locate a traffic control system. At the location of the NIC in the system it may be difficult to interfere with the electronic communication control device operation since it may not respond directly to the driver or operating system from the host machine. In contrast, traffic control software at the application layer under an operating system can only be equal to any other application for system resources and thus is easy to interfere with because it is possible for a remote computer to attach to the operating system by way of an open port and modify the traffic control software. A program can be written around the rules, as the only thing needed is opportunity to gain entry. For example some JavaScript code has been found to make it appear that a request for unwanted advertisement comes from the local machine. This happens without the knowledge or permission of the user. The request for unwanted web pages seems to have been generated locally when, in fact, is was done remotely. Sometimes this type of code is referred to as spy ware.

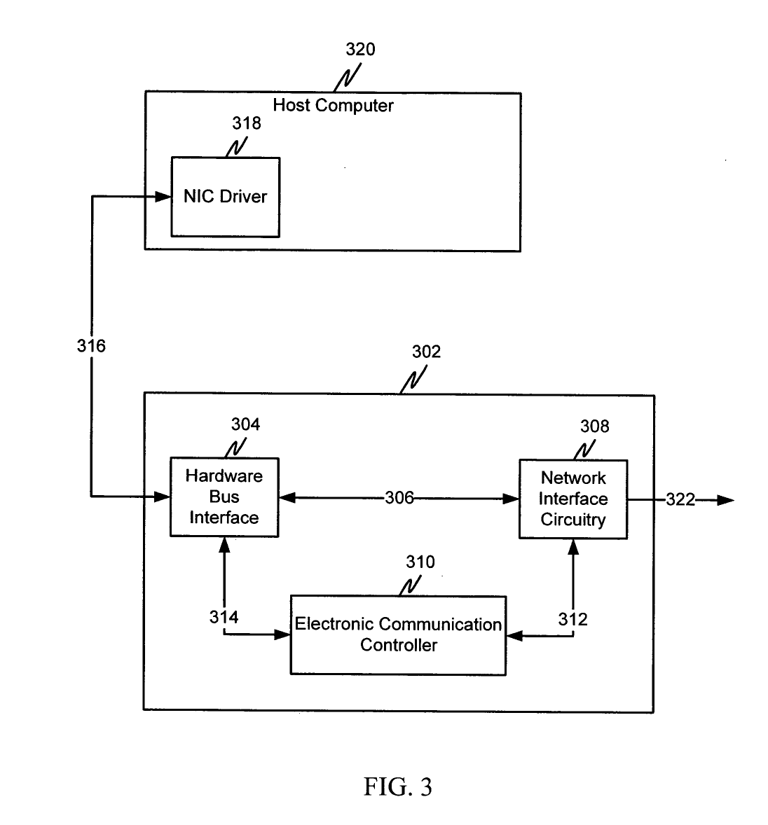

The location of a NIC card in the critical path between the computer and the network is a property that allows the electronic communication control device to perform communication control functions while remaining resistant to software tampering measures. FIG. 3 shows an example of an electronic communication control device constructed in a NIC. This construction may not require changes to the operating system or the driver.

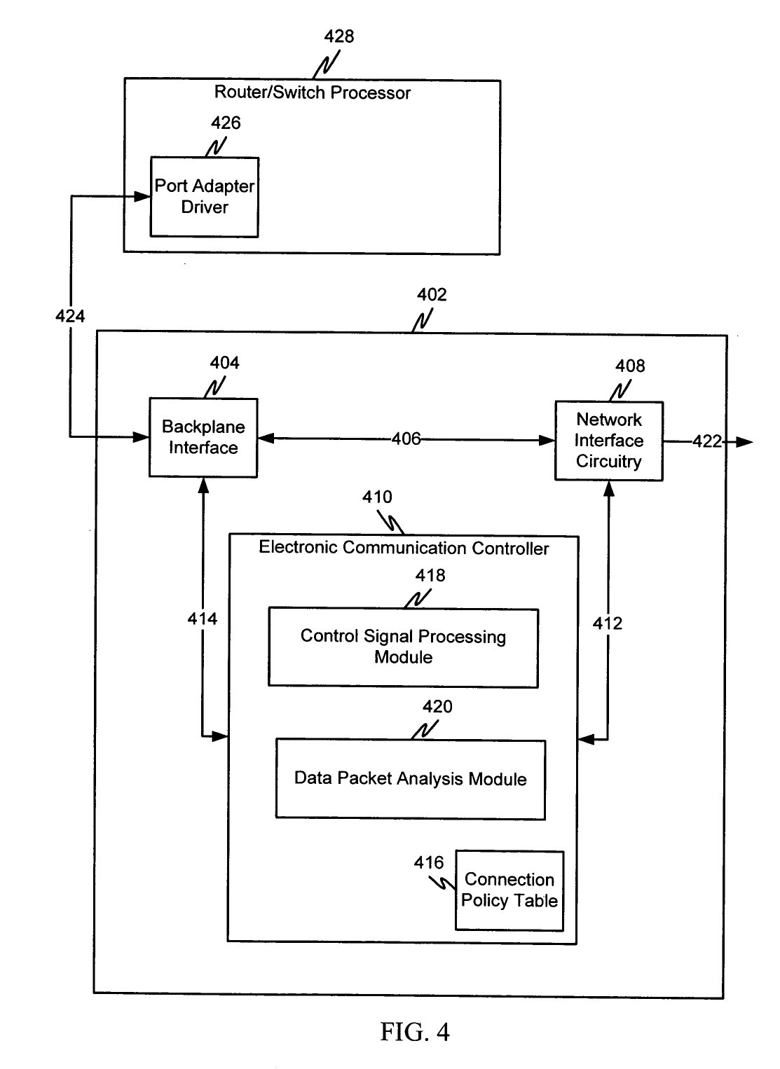

FIG. 3 is an example of the preferred embodiment in a NIC form and FIG. 4 is an example of the preferred embodiment in a port adapter form. The NIC embodiment may be typically used for computer systems, whereas the port card embodiment may typically be used for routers and switches. A difference between the NIC and port adapter variants of the electronic communication control device is that the NIC requires a driver to operate the system, whereas the port adapter may be autonomous. A port adapter card may run by itself without intervention. There may be a port adapter driver in the switch or router that performs setup and diagnostics. Setup may be needed to select modes of operation or feature sets while diagnostics may be performed intermittently during operation.

Referring to FIG. 3, within the NIC 302 there is a hardware bus interface 304, a virtual data path 306, network interface circuitry 308, an electronic communication control device 310, a network data path 312, and a host data path 314. The host computer 320 includes a NIC driver 318 and a bus 316. There is also a network interface 322 coupled to the NIC 302.

Data coming into the NIC 302 travels from the network interface circuitry 308 to the electronic communication control device 310 via the network data path. The electronic communication control device 310 processes the data. Once the data has been processed and is determined to be allowable to pass to the host computer, it travels to the hardware bus interface 304 via the host data path 314.

The virtual data path 306 is assumed by the NIC driver to be the path used by incoming and outgoing data. In fact, the incoming and outgoing data are routed to the electronic communication control device 310 over the host data path 314 and the network data path 312. The NIC driver may command either the hardware bus interface 304 or the network interface circuitry to perform a test or report status and the electronic communication control device 310 may allow those commands and responses to pass unmodified between the NIC 302 and the host computer 320.

In a LAN there may be several network computers attached along with a number of other devices. For example, a print server may be attached to the network. Other examples include a network file system (NFS) that may be attached as a redundant array of independent disk drives, tape transport or other such data storage system along with a dedicated intelligent network adapter. These devices may use a protocol that does not exist outside of the LAN environment and so may not be accessible from other systems outside the LAN. However, some may use TCP/IP and would be accessible over the Internet. Wireless hubs may be attached to a LAN. Wireless hubs often employ connection tables listing the Ethernet Address of each wireless NIC device that is allowed to use the wireless hub. This is a very safe way to control access to one side of the hub. Wireless NIC cards also have encryption circuitry that also limits access, but there is less security on the wireless side since radio receivers can recover the wireless data packet and crack encryption keys and thus allow abuse. The wire side provides limited secure access and thus the NIC Ethernet address has greater security value.

Ethernet is discussed by way of example and it should be appreciated that the electronic communication control device applies to any LAN, or other network, technology. Ethernet frame (IEEE 802.3) construction is required for data prepared for transmission over the Ethernet cable. Ethernet considers the IP datagram a payload like any other protocol payload within the IEEE 802.3 frame. The frame includes a preamble followed by a destination node address, a source node address, two octets defining frame type, an IP datagram payload, and, lastly, a CRC checksum. This frame is trustworthy within the LAN environment because the source and destination fields contain unique, non-changeable addresses burned into the NIC card at the time of manufacture. It is possible to modify a burned in address but only with great difficulty. In contrast, IP addresses are not burned in. They are entered by the user or administrator and can range from a valid registered address to an invalid unregistered address that meets number range requirements. In IPv4, dynamic host configuration protocol (DHCP) automates the generation of addresses. DHCP operated with network address translation (NAT) has been useful in protecting data networks. For example, by tradition the TCP/IP address 10.10.10.xx.255.255.255.0 is reserved for experimental networks. This address could be used on the private side of NAT. Ethernet is similarly protected.

A “spoof” is typically defined as deceiving for the purpose of gaining access to someone else's resources (for example, to use a fake Internet address so that one looks like a certain kind of Internet user or server). Spoofing a NIC Ethernet address may require advance knowledge of existing valid addresses and snooping access to the LAN wiring. The spoofing user would need to be within the private side. This is exactly what NAT tries to do, prevent outside systems from snooping into a LAN. But it can only be partially effective because of architectural issues. If a spoofing user has access to Ethernet cables then the spoofing user could devise a non-conflicting address to use to then attach to the LAN. The spoofing user still needs access to Ethernet cables to send or receive communications. These trustworthy Ethernet addresses do not leave the LAN environment because the router or switch strips these addresses from the frame as it reformats the packet for an entirely different protocol.

According to IPv6 RFC 2373, routers must not forward any packets with link-local source or destination addresses to other links. In IPv6, the first three octets in binary of an 64-bit extended unique identifier (EUI-64) are written in Internet standard bit-order where “u” is the universal/local bit, “g” is the individual/group bit, and “c” is company_id. Also, routers must not forward any packets with link-local source or destination addresses to other links. Routers must not forward any packets with site-local source or destination addresses outside of the site. The rules for router communications are changing in the conversion from IPv4 to IPv6. RFC 2464 stipulates that IPv6 packets are transmitted in standard Ethernet frames. The Ethernet header contains destination and source Ethernet addresses per the Ethernet 802.3 specification. The Ethernet payload contains the IPv6 header and IPv6 payload with padding to meet required frame size. The Ethernet interface ID is based on EUI-64 identifier, which comes from the NIC built-in 48-bit IEEE 802 address. In IPv6, only an interface can have an address or identifier. The interface address is formed from the EUI-64 by setting the “u” bit to the correct value. Also, in IPv6, an interface's built-in address is expected to be universally administered and to be unique. A universally administered IEEE 802 address or an EUI-64 is signified by a 0 in the “u” bit position, while a globally unique IPv6 Interface Identifier is signified by a 1 in the corresponding position. When the router sees the correct value the packet can be sent over the routed network, otherwise, the address stays local. Thus, TCP/IP can be used within the LAN directly and leading to an elimination of the need for DHCP and NAT.

In FIG. 4, a router or switch port adapter 402 comprises a hardware/software interface to a backplane 404, a virtual data path 406, network interface circuitry 408, and an electronic communication control device 410. The electronic communication control device 410 comprises a connection policy table 416, a control signal processing module 418 and a data packet analysis module 420. A router or switch processor 428 connects through a port adapter driver 426 via a backplane 424 to the router or switch port adapter 402. A network connection 422 is coupled to the port adapter 402.

In operation, the electronic communication control device 410 processes any control signals and responses in the control signal processing module 418. The data packet analysis module 420 analyzes data packets and, and among other things, compares and matches senders and receivers using the connection policy table 416 and identifies and communicates with the electronic communication control devices using open or covert protocols.

Referring back to FIG. 3, the electronic communication control device 310 may have an internal construction similar to the electronic communication control device 410 of FIG. 4.

FIG. 4 shows how the electronic communication control device could be implemented as a port adapter module for a router or switch. Routers and switches are often constructed to be modular so that the basic unit has a backplane with multiple positions for circuit card modules with a back plane connector and a telecommunication network connector. The purpose of the circuit card, also called a port module or port adapter, is to configure a router or switch with a specific telecommunications network capability. Examples of telecommunication networks include fiber, T-Carrier, ATM or SONET. A router or switch may have many port modules installed. The electronic communication control device can be integrated into a port module to provide the electronic communication control device capability to the basic port module unit. Another example is a router or switch constructed with the electronic communication control device built into the router or switch instead of being constructed into each port adapter. In this embodiment the router or switch would still have the same the electronic communication control device capability as a router or switch with the electronic communication control device within each port module. The electronic communication control device enabled router ports can recognize other electronic communication control device routers or switches and the electronic communication control device enabled hosts.

FIG. 5 shows an exemplary embodiment of an electronic communication control device 50 in accordance with the present invention. Specifically, FIG. 5 shows an embodiment comprising a three-chip (three semiconductor device) solution. The three basic hardware elements of the electronic communication control device hardware are the accelerator, processor, and memory. The first semiconductor device is a communication control processor 502. The second device is a PLD hardware accelerator 504. And the third semiconductor device is a memory module 506.

The communication control processor 502 comprises a high speed electrical interface 514 coupled to a network interface 550, a hardware bus interface 552, a first bus 508, a master controller 516, a local RAM 536, a local ROM 538, a bus controller 526, a second bus 510, common ROM 528, common RAM 530, and subordinate processors 518-524.

In FIG. 5, the RISC master controller and subordinate processors may be Power PCs, for example, or any type of processor. The first bus 508 connects the high-speed electrical interface 514 with the master controller 516 and the bus controller 526. The second bus 510 connects the subordinate processors 518-524 to the bus controller 526, the common ROM 528, the common RAM 530, the PLD hardware accelerator 504, and the memory module 506. The third bus 512 connects the bus controller 526 and the PLD hardware accelerator 504. A control system operates on the master controller 516.

For example, the control system for the second bus 510 could be arbitrated such that requests for bus access may appear over several control lines and each device on the bus has a control line to the bus controller 526. In addition, the master controller 516 may set bus access priority among the devices based on a performance loading algorithm where the state of each device on the bus is monitored by the master controller 516, which, in turn, signals the bus controller 526 as to the order of priority. For example, if the PLD 504 were stalled because it had data to send and could not wait for the other devices, then it may be granted higher priority. If a subordinate processor were stalled and needed to be reset, it may be placed at the bottom of the priority list since it may not have a significant impact on device operation.

In operation, the PLD 504 may be much faster than any subordinate processor, so the PLD 504 may merit a dedicated high speed bus back up through the bus controller 526 to the high speed interface 514.

The communication control processor 502 may be designed in various ways based upon contemplated uses of the invention. For example, the bus architecture may be arranged differently and memory may be arranged differently. Further, the communication control processor 502 may associate parallel processing techniques with internet communication management. Thus, the exemplary embodiment of an architecture comprising a master controller, a high speed electrical interface, and a uniquely designed PLD to execute complex tasks such as de-convolving a frame in a single operation cycle may be desirable. Further, it may be desirable for the second bus 510 to have a data width equal to the frame width. And ROM and RAM may be incorporated directly into the communication control processor 502, as in a one- or two-chip solution.

The master controller includes a local RAM 536 and a local ROM 538. The first subordinate processor 518 includes a local ROM 540 and a local RAM 542. The second subordinate processor 520 includes a local RAM 544. The third subordinate processor 522 includes a local RAM 546. The fourth subordinate processor 524 includes a local RAM 548.

The memory module 506 is comprised of a ROM 532 and a RAM 534 memory.

The high-speed electrical interface circuitry 514 is coupled to the network connection 550 and the host computer connection 552.

Although a specific distribution and configuration of processing and memory is shown in FIG. 5, it should be appreciated that the electronic communication control device of the present invention may be distributed, or co-located, and configured in various ways in accordance with a contemplated use of the invention.

In operation, the master controller 516 manages the activity of each subordinate processor (518-524). For example, an incoming high-speed data packet may be separated from the serial data stream and sent to a subordinate processor for processing. This process may be repeated for each data packet, until all subordinate processors are fully utilized. Each individual unit may operate at relatively slow clock speeds, or may operate at relatively high clock speeds. Together, the subordinate processors, operating in parallel may process large amounts of data at line speeds. The master controller 516 attempts to keep the electronic communication control device continuously busy and as fully utilized as possible.

Data communication interface structures match the gate array of the PLD with high-speed I/O channels. The electronic communication control device operates within the network interface adapter environment in conjunction with common signaling circuitry.

FIG. 5 shows an example of how the electronic communication control device could be designed from standard logic libraries and field programmable gate arrays (FPGA). A NIC can be designed to cover a large range in data connection speeds including Gigabit Ethernet. The electronic communication control device is designed to keep up with NIC operating speed. FIG. 5 also illustrates the parallel processing architecture of the electronic communication control device. Using the power and speed of the parallel processing architecture, the electronic communication control device can keep up with various LAN topologies and protocols. While FIG. 5 is an example, it should be appreciated that there are other arrangements that could work equally well. While a three chip solution is shown in FIG. 5, it should be appreciated that other alternatives are possible, such as, a two-chip solution or a one chip solution.

Speed is a major factor in determining a specific chip solution. More speed may require more parallel processors, which in turn may use more substrate surface area. FIG. 5 shows a total of five processors, for example Power PC RISC cores, stenciled onto the semiconductor device. The number of processors shown is for illustration purposes. It should be appreciated that the electronic communication control device may need only one subordinate processor. Further, the hardware accelerator PLD 504 can function as a subordinate processor executing specialized instructions. These specialized instructions could, for example, decode an entire packet in a single clock cycle and store the component variables in memory where the subordinate processor can operate on the data with general RISC instructions. By using accelerator hardware, a parallel processor could decode an incoming packet while the RISC is processing a previous packet. The accelerator can also build the packet in the same way as it was disassembled. The feature of providing a custom accelerator with the RISC processors or PLD allows the electronic communication control device to operate in real time. By way of example let the clock speed be 100 MHz or 0.1 microseconds per cycle. The accelerator PLD may decode a 1500 bit packet in one cycle. Checking the communications policy table may require 4 clock cycles. Retransmitting back into the PCI may take 1 clock cycle to reach the interface circuitry. Thus, the total elapsed time to decode, check and retransmit is 0.6 microseconds. Packets that are not allowed to pass will break out of real time and can be handled by queue management. Therefore, real time only applies to packets cleared to pass. The 0.6 microsecond delay will not affect streaming audio or video. In practice a transaction must first be setup by protocol and the electronic communication control device can clear subsequent packets faster than the first packet so clearly all packets do not suffer the same processing delay. In 0.6 microseconds in a Gigabit Ethernet system, which is a serial system, 600 bits would be clocked into the receiver. If a packet were 1500 bits it would take 2 microseconds to receive a packet and 2 milliseconds to receive a packet in standard 10 MHZ Ethernet.

Two properties of digital circuits are uniquely combined to create the operating speed of the electronic communication control device: clock speed and logic architecture. Logic architecture refers to a bus architecture for multiple parallel transfers. For example, in FIG. 5 suppose there is one independent parallel bus for each RISC processor containing X number of address lines and 32 data lines. Only a small number of address lines are required because of finite memory. If total on chip addressable memory were limited to less than 32 Meg of RAM and ROM then 15 address lines per processor plus 32 data lines and 4 chip select lines would bring the total to 51 lines. The chip select lines signal the bus controller which device on board the processor to connect to. Four lines means a processor could connect to 16 devices. The off chip portion of the bus counts as one on chip device. Each processor performs analytical work utilizing a second address and data bus for private memory. Data operations within private memory do not necessarily affect the bus controller.

Data packet headers may be fixed. A large FIFO could receive a data packet and input it into one large register where in one operation each header variable could be separated and stored in memory. The memory can be a common memory accessed by the processors. Thus, each RISC processor has more time to process data. Additional processors can be added until the physical die space is consumed. Other factors related to packaging and pin management may come into play.

In the exemplary embodiment shown in FIG. 5, the chipset is interconnected and includes a high-speed parallel bus architecture. The first bus 508 interconnects the master controller 516, the high-speed electrical interface 514 and the bus controller 526. The second bus 510 interconnects the electronic communication control device processor unit, the PLD hardware accelerator 504 and the memory module 506. The second bus 510 ties together all three chips. The third bus 512 interconnects the bus controller 526 and the hardware accelerator 504.

Each of the three buses is terminated and controlled by the bus controller 526. The first bus 508 is a simple bus connecting the master controller 516, high-speed electrical interface 514 and bus controller 526. Internet data packets are processed via the high-speed electrical interface 514. The master controller 516 keeps track of Internet transactions. It assigns a subordinate processor (518-524) to a transaction. For example if a transaction were email where jsmith@xyz.com connected to an IMAP server, then the master controller 516 may assign the third subordinate processor 522 to all data packets associated with that transaction. If the third subordinate processor 522 has additional capacity then the master controller 516 can add additional transactions to the third subordinate processor 522 tasks.

A subordinate processor can be assigned additional transactions until processing capacity is nearly full. Packets are received and transmitted through the high speed electrical interface 514, which may be a serial or parallel interface. The bus controller can organize the incoming packet and put it into temporary storage in preparation for assignment. The master controller 516 assigns the incoming packet to the third subordinate processor 522 and provides an address where the packet is stored. The third subordinate processor 522 can signal the bus controller 526 to send the packet to the accelerator 504 by way of the third bus 512 and, by way of the second bus 510, instruct the accelerator 504 to decode the packet and store the results in the memory module 506 along with an image of the original packet. In this example, the incoming packet is compared to the policy table managed by the master controller 516 and is allowed to pass the interface. The third subordinate processor 522 signals the master controller 516 that the packet is good and sends the original packet image back to the bus controller 526 where it is input to the high-speed electrical interface 514 for transmission across the PCI Bus to the host computer.

The master controller 516 has local RAM 536 and local ROM 538. The local ROM 538 contains the executable program to perform basic operations and boot the system to the main ROM 532 on the second bus 510. The main ROM 532 stores the analytical and operational software. The main RAM 534 serves as a common storage system between the subordinate processors and the accelerator 504. For example, the communications policy table could be stored here. The memory module 506 provides additional software storage and a storage area for non-real-time processing.

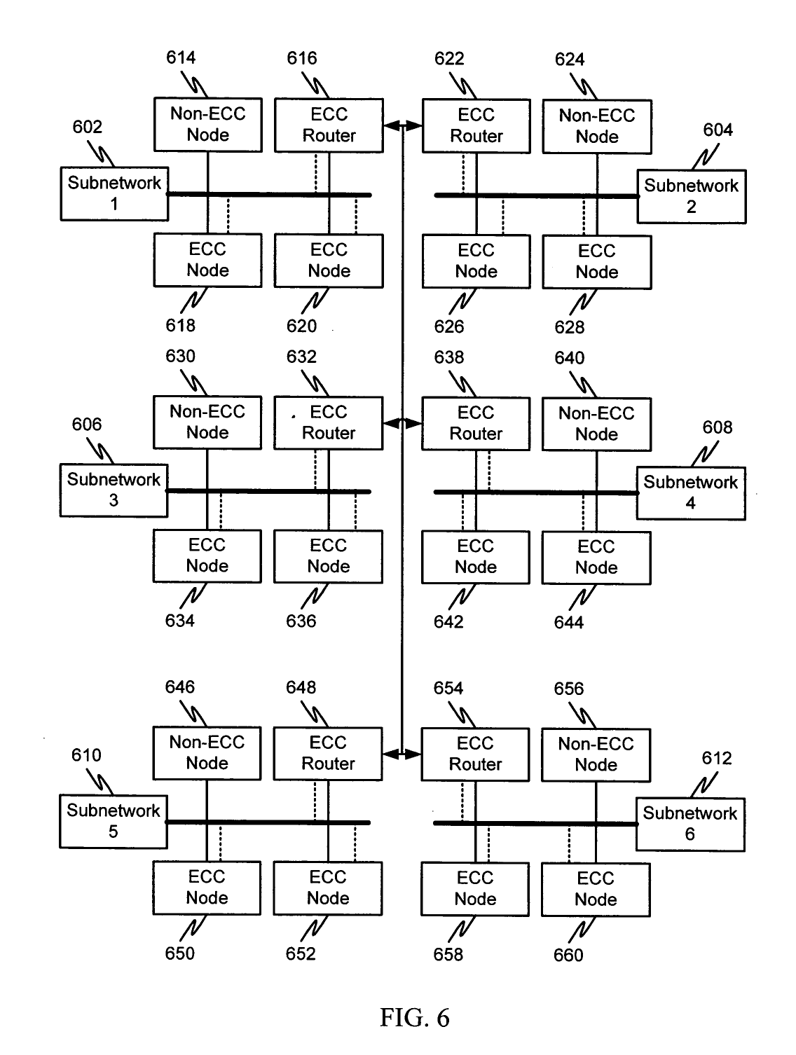

FIG. 6 shows an example of an ad hoc network comprising electronic communication control devices. In particular, FIG. 6 shows six subnetworks (A-F). Within each subnetwork are nodes (host computers) with network interface adapters connecting them to the Ethernet network. The nodes having electronic communication control devices are labeled “ECC Node” to distinguish them from the nodes that do not contain electronic communication control devices “Non-ECC Nodes.” Each subnetwork host has a NIC connecting it to the router or network switch. There are two lines shown connecting ECC nodes to the subnet, the solid line represents a conventional Ethernet and TCP/IP connection. The dashed line represents the ad hoc network communications between ECC nodes. The routers are interconnected with a router network 670. Network switches are intelligent routers that make connections based on criteria in OSI levels 2 or 3.

Subnetwork A comprises a non-ECC node 614, an ECC router 616, a first ECC node 618 and a second ECC node 620. Subnetwork B comprises a non-ECC node 624, an ECC router 622, a first ECC node 626 and a second ECC node 628. Subnetwork C comprises a non-ECC node 630, an ECC router 632, a first ECC node 634 and a second ECC node 636. Subnetwork D comprises a non-ECC node 640, an ECC router 638, a first ECC node 642 and a second ECC node 644. Subnetwork E comprises a non-ECC node 646, an ECC router 648, a first ECC node 650 and a second ECC node 652. Subnetwork F comprises a non-ECC node 656, an ECC router 654, a first ECC node 658 and a second ECC node 660. The ECC routers (616, 622, 632, 638, 648, and 654) are all interconnected by a router network 670.

FIG. 6 is a well-developed ad hoc network in that most of the host systems and all of the routers are equipped with ECC port cards. In operation, within a subnetwork, the electronic communication control device may limit connections to non-ECC nodes. Frames from non-ECC stations are subject to table based connection criteria. Thus an ECC node can send Ethernet frames containing any data type to another ECC node. ECC node to ECC node communication within the ad hoc network is mostly considered trustworthy, but there may be exceptions for certain designated nodes.

For example, the non-ECC node 614 on subnetwork A may send an Ethernet frame containing a redirected frame from the ECC router 616 to the first ECC node 618. The first ECC node 618 packet analysis result may be that the frame is a redirected frame from an unwanted connection. Each ECC node is able to converse with routers across the full range of a router protocol. The dashed line connecting an ECC node to the subnetwork represents this connection. It may appear to a router that the ECC node is another router when, in fact, it is not. The ECC node may hide the host computer system behind a phantom router. Continuing with the example, data packets may be buffered in a holding area while an attempt is made to identify the sending source and compare that source to the connection policy table. If the sending source is identified and listed in the connection policy table as negative, then the first ECC node 618 will refuse the connection and the buffered frames may be discarded. If the sending source is not identified then the processor checks the connection policy table for unknown sender authorization. The ad hoc network permits a user to set authorization for unidentified senders based on port assignments and/or other criteria. If the connection table is set to receive packet from unidentified senders, then the buffered packets are sent on to the host system using an interface like the one shown in FIG. 3 for example.

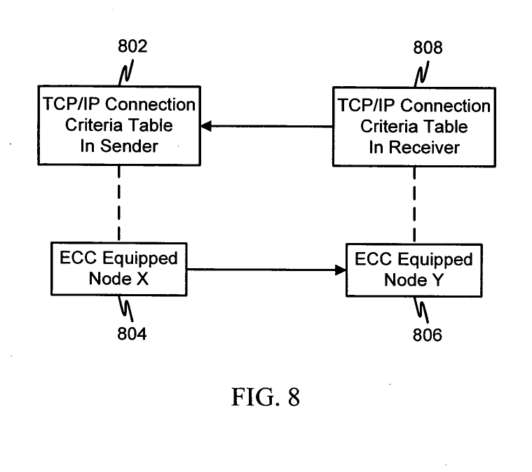

The communication policy table may contain entries that indicate to the hardware what types of traffic to allow and from whom to allow it. The ECC nodes may have structures that can decode data packets with minimal processor effort, for example, registers and masks that are designed for IPv4 and IPv6 headers and Ethernet frame components. These structures enable the hardware to quickly decode the packet frame, analyze it and compare it against the communication policy table. The receiving ECC node host can receive all incoming traffic until the user begins to set negative status against specific Internet frame parameters and payload contents. Once negative status has been placed on certain packets, the receiving ECC node will share the negative criteria with those ECC nodes that are trying to communicate with it. See FIG. 8 for an example of how the system communicates within existing structure.

In another example, an Internet data packet may be sent from the first ECC node 618 of subnetwork A to the second ECC node 628 of subnetwork B. The first ECC node 618 of subnetwork A is attempting to send SMTP mail to the second ECC node 628 of subnetwork B. The first ECC node 618 of subnetwork A sends an Ethernet frame to the ECC router 616. The subnetwork A ECC router 616 strips the Ethernet frame down to the payload and repackages it as a router frame directed to the subnetwork B ECC router 622 by way of a route table using a router discovery protocol. Each router performs router discovery and learns the connections or hops as distant routers respond to the discovery protocol. Since, in this example, the subnetwork A ECC router 616 is directly connected to the sub network B ECC router 622, the hop table is simple.

If several paths to a distant router exist, another protocol, called ‘open shortest path first’ (OSPF) that finds a quick sure way using a minimal number of other routers, may be used. OSPF also ensures router connections do not circle back and form wasted loops. The router adds hops and tics to the paths. A hop is a jump across the router and a tic is a one eight-time marker. The hops and tics help the subnetwork A ECC router 616 to compute the shortest reliable path to the second ECC node 628 of subnetwork B if OSPF is required. The ECC module in the second ECC node 628 of subnetwork B analyzes the data packet and detects the SMTP protocol. The packet may be buffered and stored in a temporary holding area while the connection policy table is checked. In this example, the table contains an entry for the sender, the first ECC node 618 of subnetwork A, that indicates connections are refused for a list of well-known ports some of which may be related to SMTP. The second ECC node 628 of subnetwork B then issues an update to the ECC module in the first ECC node 618 of subnetwork A indicating the ports and TCP/IP address for which data packets are refused. The first ECC node 618 of subnetwork A then provides a corresponding connection failure message to the local application layer as shown below in Table 1. The user of the first ECC node 618 of subnetwork A is then notified through the application of the failure to send SMTP mail to the second ECC node 628 of subnetwork B. If the user of the first ECC node 618 of subnetwork A persists in trying to send SMTP mail to the second ECC node 628 of subnetwork B the ECC module in the local workstation will block the message from reaching the subnetwork A ECC router 616 and continue to send the failure notification back up to the local application layer. In this manner, subsequent data packets are blocked locally from taking bandwidth on the network. If the first ECC node 618 of subnetwork A were not ECC equipped then the failure message would have come from the second ECC node 628 of subnetwork B directly to the first node 618 of subnetwork A. The above example illustrates the connection precedence in an ad hoc network. The ECC modules will attempt to keep communications between ECC modules first and then communicate with the host second.

For example, the Internet control message protocol (ICMP) may be used with an ad hoc network. The Internet may operate with a connectionless multiplexing scheme and may rely on various protocols to accomplish a dynamic multiplexing scheme. ICMP is one set of rules that may be implemented by routers using IPv4 to resolve congestion, delays, destination errors and retransmissions. There are other routing protocols that can be used, for example, open shortest path first. Table 1 lists the ICMP messages by Type.

TABLE 1
Destination Unreachable Codes

| Type Code | ICMP Message Nomenclature |
|---|---|
| 0 | Net unreachable |
| 1 | Host unreachable |
| 2 | Protocol unreachable |
| 3 | Port unreachable |
| 4 | Fragmentation Needed and DF set |
| 5 | Source route failed |

Continuing with the example above, the SMTP mail message may have also been addressed to the first ECC node 626 of subnetwork B which did not block the reception of SMTP from the first ECC node 618 of subnetwork A. The SMTP mail data packets pass through the ECC module up through the protocol stack to the application layer of the first ECC node 626 of subnetwork B. On subsequent messages from the first ECC node 618 of subnetwork A with a list containing both the first ECC node 626 of subnetwork B and the second ECC node 628 of subnetwork B the local ECC module in the first ECC node 618 of subnetwork A will attempt to parse the outgoing data packets and remove references to the second ECC node 628 of subnetwork B. If the parse is successful, then a connection failure message is issued from the first ECC node 618 of subnetwork A to the application layer indicating failure for the connection to the second ECC node 628 of subnetwork B. But the message continues on to the first ECC node 626 of subnetwork B. If the parse is not successful, the message goes out from the subnetwork A ECC router 616 to subnetwork B ECC router 622 to both the first ECC node 626 and second ECC node 628 of subnetwork B. The second ECC node 628 of subnetwork B will refuse the message and reply with connection failure, however, the first ECC node 626 of subnetwork B will receive the message as in the normal course of events. Eventually, the user of the first ECC node 618 of subnetwork A may remove the ID of the second ECC node 628 of subnetwork B because the connection is never made.

In yet another example, an ad hoc network is used to communicate messages in IMAP message protocol. Users on subnetwork D may be IMAP users and the first ECC node 642 of subnetwork D may be an IMAP server. Mail folders for each user on subnetwork D are processed through the IMAP server on the first ECC node 642 of subnetwork D. The sender, as in the previous example, may be the first ECC node 618 of subnetwork A, which is processing large mail lists and, for example, is sending mail to every email account in subnetwork D. The first ECC node 642 of subnetwork D and the second ECC node 644 of subnetwork D refuse email sent from the first ECC node 618 of subnetwork A. The ECC module of the IMAP server is configured to decode the IMAP protocol and has been set up by a system administrator to function as a guard for the IMAP server. For each account managed by the IMAP server, the ECC module has a policy table entry for connections. In this configuration, port numbers may be of little value, rather the ECC module may decode each outside sending source and either allow or block the connection. The administrator will be able to set rules specific to the ECC module in the IMAP server that all message traffic within the subnetwork and domain are allowed to connect, and all messages from outside the subnetwork and domain are to be analyzed. The administrator may further stipulate that all messages are passed except those specifically blocked by each IMAP user account. The administrator could conversely choose to block connections to a specific subnetwork or node on that subnetwork. The ad hoc network can block messages by any parameter that is present in and detectable by the message parser. For example, the ad hoc network can block a message with a blank subject field, a message containing certain words or phases, messages where the subject line does not match the body text, and/or messages containing hypertext, JAVA or any other types of software instructions. Two similar messages one formatted in hypertext and the other plain text may be treated differently. For example, suppose both messages are about interest rates. One message is formatted in hypertext and the other in plain text. The plain text message may be allowed through but the hypertext message may be blocked.

It is important to note that an email server may receive messages in many presentation protocols and the ad hoc network may operate with IMAP and/or any other mail protocols. The previous example may also be applicable between the IMAP server and the email sender. The ECC module in the IMAP server becomes an agent for each IMAP user because of the distributed way mail is handled on behalf of the recipient. The ECC module may process data packets at line speeds. Thus causing no slow down in the IMAP server processing. Further, the parallelism of the ECC module may be sufficient to operate at gigabit line speeds.

FIG. 6 shows how a limited number of electronic communication control device equipped systems would function in a network. While, the ad hoc network may work best if there are a large number of ECC nodes, it still functions with a small number of nodes. The ad hoc network policy table propagation helps keeps unwanted traffic of the Internet data paths. A difference between an ad hoc network with many nodes and one with few nodes may be at which point a multiplexing decision is made. If there is only one ECC node in the network, it should preferably be coupled to a user's host computer to fully protect the user. The ECC module may not support a user multiplex connection policy table if the hardware is not locally installed. The ECC module can determine the address of the local machine from the local machine and identify routers on the network. ECC nodes recognize each other as part of an ad hoc network and cooperate in a unique way as members of the ad hoc network. ECC nodes on different ad hoc networks and outside a private network will be somewhat more formal in cooperation. For example, an ECC equipped router port on a carrier network may not store full TCP/IP addresses of each ECC node in the private network. Instead, addresses may be translated to still another numbering system suited to a continuous sequence of numbers.

Blocks may be formed by a common policy criteria so nodes in the private network could opt in to pass traffic rather than refuse the connection or opt out. For example, all the addresses in a private network electing not to receive email from a user, for example sender@xyz.com, are in block B and those electing to receive mail from sender@xyz.com are in block A. The carrier's ECC port module closest to “sender” in the path would flag the message that may be addressed by a list entry. A list entry may remain active until it reaches a router port closer to mybusiness.com that may still be in the carrier's network or may be at the mail gateway at mybusiness.com where the block B users are listed by unit address. The mail packet may be refused at that point with the entire list but those listed in block A would receive a message copy. Sender@xyz.com would receive the rejected or bounced email. Sender@xyz.com would then prune the recipient list and resend the message or resend the message with individual addresses.

A level of protection exists if the network administrator deploys ECC port cards at router and switch points. These ECC ports will enforce network policy decisions made by the administrator. The local user may be a server. Locating an ECC module in a server computer may be desirable because the ECC module may protect the server from hostile nodes while allowing for a secure remote network connection for administration.

In another example, ECC modules may be incorporated into servers for remote network administration. The ECC module may keep a history of analysis, peg counts and connections. The ECC module may also keep track of how many times port scans have been performed. The ECC module may keep a count of how many times ‘rlogin’ has been unsuccessfully attempted. The ECC module may keep a history of distant subnetwork connection attempts and the paths used to make the attempts. This information may be useful in assessing risk.

In mail systems, there may be several types of protocol methods used for mail service. Two exemplary protocols are post office protocol (POP) and Internet Message Access Protocol (IMAP). Another exemplary protocol is Simple Mail Transfer Protocol (SMTP). The IMAP protocol may be the most complex of the three mentioned. While the ad hoc network and ECC may be discussed in terms of IMAP for illustration purposes, the ad hoc network and ECC may perform with other protocols such as POP and SMTP and/or other later developed protocols.

IMAP is a client server relationship email protocol. For example, a user may be the human operator of a host computer, the client may the software at the host computer on the network, and the server may be another computer also on the network. The mailbox typically resides at the server. The server keeps mail folders for the user. The basic folders are in box, out box (sent items), deleted mail, and draft mail.

Commands from the client are typically in the form of ASCII strings with terminators and may be decoded so the ECC hardware can determine the transactions taking place. There exists in an ECC module a mail client capable of understanding and decoding mail transactions. Mail transactions are intercepted by the ECC module and processed in the manner described below.

The mail server receives mail from other types of mail systems as well as other IMAP systems. For example, a mail server shown in FIG. 6 may be an IMAP server and the client may be the host operated by a user. In this example the mail server and client are both equipped with ECC NIC adapters. ECC NIC adapters communicate with other ECC devices on the network forming an ad hoc network. Each ECC module has a separate TCP/IP protocol stack, for example IPv6, and listens to the host it resides in. It can identify the type of host server process originating from within the computer. For example, the ECC module can automatically identify a mail server of the correct type, IMAP or POP. On the IMAP server it would listen and identify the clients attached to the server and by this implication the user. Within an Ethernet frame, ECC devices on the same network would share criteria lists. Thus ECC devices on the mail server would fill their respective communication policy tables from the data shared with other ECC devices in that subnetwork in an ad hoc manner.

A domain name server (DNS) performs the lookups between domains and the corresponding host IP address. Thus, the first part of the mail address before the @ symbol is separate from the mail domain portion following the @ symbol. Two users may have the same mail identification as long as they are on different domains.

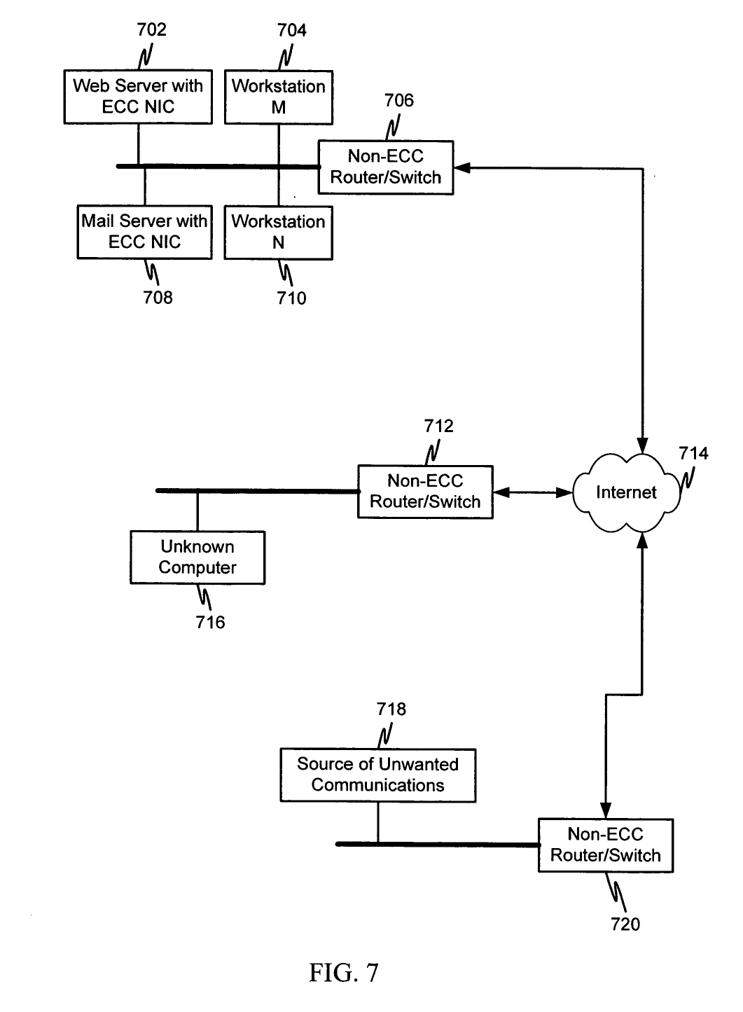

An ECC module uses criteria to selectively multiplex messages through the network interface adapter. Preferably, an ECC module may be implemented in a router and the router network through the use of port modules for maximum effectiveness. FIG. 7 shows how a limited application of ECC modules could be used with basic routers or switches to control TCP/IP multiplexing. For example, in FIG. 7 there are two distant networks shown connected to the host subnet through the router cloud and one subnet is labeled hostile.

Referring back to FIG. 6, in another example, the first ECC node 658 of subnetwork F is a hypertext server that is sending undesired message, for example, false advertising messages. The first ECC node 658 of subnetwork F advertises in such a way as to confuse Internet search engines so that searching users will be tricked into connecting to this server then be redirected to a completely different subject.

For example, a user may be searching for a link to the White House, a popular government web site. The user is offered a choice of websites from a search results page. The user reads the description and selects the false web server advertised by the first ECC node 658 of subnetwork F. ECC modules may continuously analyze data packets and detect a search in progress by way of analysis. When the false web server changes topics, ECC detects the change through page parsing and analysis. The data packets are buffered and held while the user is presented with a warning noting the change of topics between the search request and the content of the web page and an opportunity to choose to block or continue. If the user blocks the data packets, then the ECC module will attempt to reconstruct the connection history. In an ad hoc network method, a listing policy will be propagated to other ECC units in the connection path and offending web server will be blocked. In this case it is not necessary for the web search site to be ECC equipped. The tag with the offending address is block along the connection path so that the user can see the blocked message and return by way of the browser back to the search results page. If the offending web site offered nuisance code it may also be blocked.

A user of an ECC equipped NIC may set preferences. For example, a user may choose to receive simple text mail from unknown users and receive hypertext mail from trusted users. A trusted user is a user who has been identified as trusted in the connection policy table. For example, FIG. 7 shows an ECC host computer functioning as a web server 702 connected to a subnetwork with a mail server 708 and other workstations (704 and 710). A router 706 connects the subnetwork to the Internet 714. A foreign system 718 has been receiving web pages from the web server through a router 720 and has identified the TCP/IP address of the web server from another means. The foreign system 718 now tries to probe for open ports. The local administrator may have left ports open. If the foreign system can identify the open ports, they may be able to seize control of the web server. In this example, the administrator has closed ports above 256 for IP traffic outside of the country domain. The administrator also allowed traffic for all ports from a list of specific IP addresses. Even if those addresses are a list managed from the DHCP server, they will still be able to connect to all ports. An organization may have several distributed DHCP servers in the intranetwork. The ECC node will manage each list in real time. Continuing in this example, a distant network with a router 712 and an unknown computer system 716 wishes to connect with the web server to perform some contract web development. In this case the assigned port number is 2784. The local administrator has enabled the connection policy table for a distant specific system over an untrusted network. ECC modules work with routers to identify the path to the trusted distant host. In this case the distant host is limited to a specific port number. Other types of data packets for other ports will be rejected. ECC modules use router language to identify the path back to the distant user. Also, ECC modules monitor this path for any changes. If there are changes, the new path will be suspicious. Multiplexing may be suspended for a short period until a resolution can be made to see if the distant host is still trusted enough to continue. If the resolution is negative then the connection is closed down and the administrator notified. The administrator can reset the connection at an appropriate time.

FIG. 7 shows an example of how an element of the local connection policy table is propagated through an ad hoc network. Specifically, using the ad hoc network a user may indicate to the ad hoc network partial, or full, multiplex preferences. Policy table elements are referred to as multiplex preferences because a user may wish to perform TCP/IP transactions with a limited subset of remote hosts (the ad hoc network). The user may also wish to limit TCP/IP transactions to a specific field, such as, for example medicine, physics, or electrical engineering. The data packet analysis process of the electronic communication controller contains a sophisticated parsing engine. Parsing may be performed on email, web pages and/or document files to extract the nature of the message.

For example, a first node X that has an electronic communication control device sends a TCP/IP transaction to a second node Y that also has an electronic communication control device. The electronic communication control device data packet analysis in the second node may indicate that the message is of a type the local user does not wish to receive. The second node prepares a connection policy rule for transmission to the first node. The local user of the first node may have set the local policy to engage in the transaction types refuted by the second node. Since the data packet receiver has the final determination of whether to accept a message, the first node will add a line to its policy table stopping any connection to the second node before it can get to the local router. Note that the first node may not be physically associated with local user. It could be a router port having an electronic communication control device serving the first node.

Policy table elements may be perishable. In other words, rules propagated via the ad hoc network may persist indefinitely or may persist for a certain period of time. For example, the rule propagated to the first node may be enforced for a certain time. After that time, the rule will expire.

The rules for expiration include timing so that trigger points can be measured. One such point is the number of times the user at ECC node X has repeatedly tried to send the unwanted communications, also known as a peg count. If the peg count is zero the rule would expire after some time. If the peg count is non-zero then the rule may persist.

FIG. 8 shows how a policy table entry may be propagated between two ECC equipped nodes. A first ECC node 804 includes a TCP/IP connection policy table 802. A second ECC node 806 includes a TCP/IP connection policy table 808.

In operation, the first ECC node 804 may send a message, which the second ECC node 806 does not want to receive. The TCP/IP connection policy table 808 in the second ECC node 806 is updated. Since, both ECC nodes are in an ad hoc network, the policy table entry is propagated to the policy table 802 of the first ECC node 804. In the future, any undesired messages that the first ECC node 804 attempts to send to the second ECC node 806 will be blocked by the policy table entry in the TCP/IP connection policy table 802 of the first ECC node 804.

The ECC module includes a human computer interface. A web interface is provided so that a browser can present the user with a selection of ports to protect. A description of port use and how protections will work is part of the presentation to the user through the browser. A user may make selections and ports and their application interfaces may be affected. The ECC device will guard port access from outside the local intranet. Internet traffic coming into the local host may be affected by the connection policy table. If, for example, an email message arrived from an unknown user prior to a new connection policy table entry, the mail message would be delivered. After the user makes an entry in the connection policy table that affects unknown users, then any subsequent email from an unkown user will be subject to rules enforcement. If the connection policy table for unknown users were negative and a message is from an unkown computer that is ECC equipped, then the message will be analyzed and the ECC and an ECC-to-ECC message will convey a pending message notification with message abstract to the user which may be a pop-up message, or may be through the browser. If the user selects to allow the message through then a signal is sent from the local ECC host through the network to the distant ECC node holding the message to send it. If the user selects to block the message, then the local ECC node will send a message to the distant ECC node holding the message with a suggestion for deceptive or direct message failure mechanism. If the mail message analysis indicated contents were strongly-rejected, then a deceptive mechanism may be employed. If the message contents were set to reject then a direct failure mechanism may be employed. For example, the message could be left to perish in time. Thus, an unknown sender was able to successfully send a message to a user prior to a connection policy table entry, but after the ECC installation and connection policy table setup, the same sender received a connection failure notification on subsequent email attempts.

Continuing with the example, an email data packet comes into the ECC node operating using IPv6. The packet is first examined to see if it is IPv6 or IPv4. If necessary, the protocol is translated. The incoming packet may be IPv4 compliant so no translation is necessary. If the packet had been IPv6 compliant then the packet protocol would have been translated to IPv4 for the local host. The packet is first level analyzed to determine packet type. If the packet fits email, web or other well-known port processing it is sent to a corresponding analysis module. If it is another type, it may require second level processing.

Analysis outputs feed the policy-matching algorithm. This is a basic representation of how ECC is organized for illustration purposes. The policy-matching algorithm will make a disposition based on the criteria. The criteria were developed interactively with the user prior to packet analysis. If a match is made, then the state results are implemented. If a match is not made, then state results for no match are implemented.

The result of a policy disposition is to multiplex or not multiplex the data packet through the network or allow the packet into the host machine. There is a process to determine the best rejection method. For example, a packet may be left to perish, or the sender may receive a deceptive failure message. The failure message may be direct or it may be deceptive. If the data packet represented strongly-rejected spam email then ECC may send a deceptive connection failure message, such as ‘message delivery failure—recipient address cannot be found’. There are many failure mechanisms available and they can be employed advantageously by the ECC modules and ad hoc network to discourage spam. Likewise, if the data packets represented unwanted rlogin attempts from a rogue user, then ECC can attempt to gather router connection history and hold it for administrative review. This way a detailed analysis of the router connection path may yield some information about the nature of the rogue user.

It should also be appreciated that there are other application of the ECC and ad hoc network beyond spam control, such as, for example, email, hypertext filtering, and e-commerce. The ECC modules and ad hoc network may be used to communicate specific information only among certain users, or for other purposes suited to an ad hoc network. For example, the ECC modules and an ad hoc network may be used to block particular text or data from coming through in a search. Such a use may have application in schools or homes for blocking undesirable content.

Understanding how connection policy is promulgated through the ad hoc network may benefit from an understanding of how connections are setup. Routers implementing IP routed protocol are designed to compute the connections needed to deliver a session. Once a path is built, the router will typically hold that path for some length of time waiting for another series of IP transactions. If no continuing packets are exchanged between the same to end points, the path is taken down. Computers and servers in general do not communicate in router protocol. However, ECC nodes do communicate in router protocol and are thus able to appear as routers on the network if it is advantageous to do so.

As mentioned above, ECC modules may use two simultaneous TCP/IP protocol stacks: one for IPv4 and the other for IPv6. The dual stack may be useful for translations and for impersonating another router. Using this technique it will pull information from the router network about how the route was setup. Then, the ECC module will explore the possibility that other ECC machines may be in the multiplex path by probing for other units. Special data payloads contain ECC codes that will identify the nature of an ECC control packet. Through the ECC control packet, control and data will be securely exchanged between ECC nodes. If there are other ECC nodes in the connection path then the local ECC host will promulgate connection policy to the next ECC node down the line. This node in turn will do the same until the ECC node closest to the data packet source cannot connect to any more ECC nodes and is the last ECC node in the multiplex link. All ECC nodes may contain the same connection set up information and be able to compute their contribution to the link route. The connection policy promulgation will be passed using this technique down to the closest ECC node to the sending unit. The connection policy table entry may exist at the last ECC node from a few seconds to several days depending on activity level.

The ad hoc network of electronic communication control devices and the method for forming an ad hoc network, as shown in the above figures, may be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions described herein can be used to implement an ad hoc network of electronic communication control devices according to this invention.

Furthermore, the disclosed ad hoc network of electronic communication control devices may be readily implemented in software using object or object-oriented software development environments that provide portable source code that can be used on a variety of computer platforms. Alternatively, the disclosed ad hoc network of electronic communication control devices may be implemented partially or fully in hardware using standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The ad hoc network of electronic communication control devices illustrated herein can readily be implemented in hardware and/or software using any known or later developed systems or structures, devices and/or software by those of ordinary skill in the applicable art from the functional description provided herein and with a general basic knowledge of the computer and network communication arts.

Moreover, the disclosed ad hoc network of electronic communication control devices may be readily implemented in software executed on programmed general-purpose computer, a special purpose computer, a microprocessor, or the like. In these instances, the ad hoc network of electronic communication control devices of this invention can be implemented as a program embedded on a personal computer such as a JAVA® or CGI script, as a resource residing on a server or graphics workstation, as a routine embedded in a dedicated encoding/decoding system, or the like. The system can also be implemented by physically incorporating the ad hoc network capability of an electronic communication control device into a software and/or hardware system, such as the hardware and software systems of network communication equipment.

It is, therefore, apparent that there is provided in accordance with the present invention, an ad hoc network of electronic communication control devices and method of forming an ad hoc network. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A multiplex controller for use in an ad hoc network, said multiplex controller comprising:
means for communicating a first message in a first protocol;
means for communicating a second message in a second protocol by placing the second message within the first message, wherein the second protocol is transparent to devices communicating only in the first protocol, and wherein the second message includes multiplex control information that identifies a node on the ad hoc network, and information for blocking unwanted messages at a level between a network and a processor;
means for identifying the second message in the second protocol within a received message in the first protocol;
means for transmitting, in the second protocol, first data placed in a database accessible by the multiplex controller; and
means for updating the database with second data received in the second protocol.

2. The multiplex controller of claim 1, wherein the multiplex controller is constructed to operate within a network interface.

3. The multiplex controller of claim 1, wherein the multiplex controller is constructed to operate within a line card.

4. The multiplex controller of claim 1, wherein the first data includes information identifying a sender of undesired messages.

5. The multiplex controller of claim 1, wherein the second data includes information identifying a sender of undesired messages.

6. The multiplex controller of claim 1, further comprising means for restricting access to a host processor based on the connection policy table.

7. The multiplex controller of claim 1, further comprising means for propagating a local connection policy table to a node within the ad hoc network.

8. An ad hoc network comprising:
a first network interface including a first electronic communication controller;
a second network interface including a second electronic communication controller;
wherein the first and second electronic communication controllers are constructed to communicate in a first protocol and to communicate in a second protocol unique to the first and second electronic communication controllers and to transport a message in said second protocol within a message communicated in said first protocol such that an ad hoc network is formed of nodes communicating in the second protocol, and
wherein the ad hoc network controls multiplexing of electronic communications by analyzing network data traffic and restricting access by matching senders with receivers.

9. The ad hoc network of claim 8, wherein the first network interface is coupled to a first host computer and the second network interface is coupled to a second host computer.

10. The ad hoc network of claim 8, wherein the first network interface is coupled to a first data switch and the second network interface is coupled to a second data switch.

11. The ad hoc network of claim 8, wherein the first network interface is coupled to a host computer and the second network interface is coupled to a data switch.

12. The ad hoc network of claim 8, wherein when the first electronic communication controller determines that the second electronic communication controller is in the same domain, the first electronic communication controller and the second electronic communication controller exchange additional data to enable negative multiplexing of unwanted communication.

13. The ad hoc network of claim 8, wherein the first network interface and the second network interface analyze incoming data traffic for a local processor corresponding to each of the first network interface and the second network interface against a policy table communicated between the first network interface and the second network interface.

14. A method of forming an ad hoc network comprising:
receiving a data packet in a first protocol at a first node;
analyzing the data packet to determine if a message in a second protocol is contained within a payload of the data packet in the first protocol; and
extracting the message in the second protocol and processing the message, if the message was found within the payload of the data packet in the first protocol,
wherein processing the message includes:
identifying a plurality of nodes;
establishing an ad hoc network comprising the identified nodes;
identifying the sender of the message; and
adding information corresponding to the sender to a database.

15. The method of claim 14, further comprising the step of creating a local connection policy table.

16. The method of claim 15, further comprising the step of adding data identifying a computer on the network to the connection policy table.

17. The method of claim 16, further comprising the step of propagating the connection policy table to a node within the ad hoc network.

18. The method of claim 17, further comprising the step of comparing a portion of an incoming data message with data stored in the connection policy table.

19. The method of claim 18, further comprising the step of forwarding data packets that meet policy table criteria to a host processor.

20. The method of claim 14, further comprising the step of creating covert electronic communication control device to electronic communication control device connection messages for communication within the ad hoc network.

21. A network interface card comprising:
a master control processor embedded in the network interface card, the master control processor including:
a router module configured to communicate, in a router protocol, a request for router information and to receive router information from a router, wherein said router module is configured to cause the electronic communication control device to appear to the router as another router; and
a processing module configured to analyze network data traffic and to provide multiplexing control by blocking unwanted traffic, wherein the master control processor is disposed in a data path between a network and a host processor such that multiplexing control is performed prior to message data being processed by the host processor.

22. The network interface card of claim 21, wherein the processing module is configured to process electronic communication data packets.

23. The network interface card of claim 21, wherein the processing module is configured to create a policy table.

24. The network interface card of claim 23, wherein the processing module is configured to manage the policy table by updating entries in the policy table based on the router information.

25. The network interface card of claim 23, further comprising a module to determine a blocking node within the ad hoc network based on the router information.

26. An electronic communication apparatus for a terminal node connected to no more than one router, said electronic communication apparatus comprising:
a communication module to communicate a first message in a first protocol and to communicate a second message in a second protocol by placing the second message within the first message, wherein the second protocol is transparent to devices communicating only in the first protocol; and
a router module to communicate, in a router protocol, a request for router information and to receive router information to determine network topology sufficient to select a blocking node on an ad hoc network, the blocking node being selected by an ad hoc network multiplex control strategy, wherein the second message includes ad hoc network multiplex control information corresponding to the blocking node on the ad hoc network and information for blocking unwanted messages at the blocking node, wherein the blocking node is separate from the terminal node.

27. The electronic communication apparatus of claim 26, wherein the communication module is configured to exchange data to enable multiplex control of unwanted communication with another node on the ad hoc network.

28. The electronic communication apparatus of claim 26, wherein the router module communicates with a router through a same port used by the electronic communication apparatus for regular network communications.

29. The electronic communication apparatus of claim 26, further comprising a module to determine a blocking node within the ad hoc network based on the router information.

30. The electronic communication apparatus of claim 26, further comprising a module to determine a node within the ad hoc network based on the router information and to send a policy table update message to the node.
